(19) United States
(12) Patent Application Publication
(10) Pub. No.: US 2007/0156381 A1
(43) Pub. Date: Jul. 5, 2007

(54) Device for simulation of the real world by asynchronous and chaotic processing

(75) Inventors: Jacques Tisseau, Brest (FR); Fabrice Harrouet, Guipronvel (FR); Pascal Redou, Morlaix (FR); Sebastien Kerdelo, Brest (FR); Christian Charles, Plougonvelin (FR)

Correspondence Address: OBLON, SPIVAK, MCCLELLAND, MAIER & NEUSTADT, P.C., 1940 DUKE STREET, ALEXANDRIA, VA, 22314, US

(73) Assignees: Cervval, Plougastel Daoulas (FR); Ecole Nationale D'Ingenieurs de Brest, Brest Cedex 3 (FR)

(21) Appl. No.: 10/586,610

(22) PCT Filed: Jan. 20, 2005
(86) PCT No.: PCT/FR05/00124

§ 371 Date: Jan. 4, 2007

(30) Foreign Application Priority Data
Jan. 20, 2004 (FR) 0400488

(51) Int. Cl. G06F 9/45

(52) U.S. Cl. 703/22

(57) ABSTRACT

A computer to permit programming by active objects in multi-task mode, representative of systems for simulation, includes a device for real world simulation. The device includes an object simulation program for combined evolution of at least some of the active objects, including i) objects of state each containing at least one item of spatial and/or temporal and/or property data defining a current state, ii) interaction objects each containing the definition of at least one of the state objects and at least one function applicable to at least one of the state objects and defining at each point in time the simulated system topology, and iii) a simulation manager operable by sequences on a selection of interaction objects and to activate each interaction object only once for each sequence, according to an order varying in an at least partially random manner from one sequence to the other such as to apply each of the functions thereof to the actual state of each state object designated thereby for the evolution of the state thereof towards a new state.

The invention relates to computer simulation of the real world, and in particular the temporal evolution of media which are objects of physical and/or chemical and/or biological phenomena.

As the person skilled in the art knows, numerous objects (animate or inanimate) or substances interact with media in which they are placed. When man conceives of a new object, such as a boat for example, or when he tries to understand a reaction mechanism, such as for example the development of a cancer, it is generally impossible for him to take into account all the interactions or at least the main ones, particularly when he is using models. Consequently, it often happens that the final object does not achieve the results anticipated, or that the explanation put forward does not correspond to reality due to the complexity and/or combination of reactions present in the real world. Thus, a boat may be found incapable of withstanding certain conditions at sea, even when it has been the subject of research previously carried out, including tests carried out in dry dock.

In order better to anticipate the final behaviour of an object or product, or better to understand a reaction mechanism, numerous industrial firms and researchers use devices for the computer simulation of the real world.

These simulation devices are generally based on modeling of the physical and/or chemical and/or biological phenomena in the form of differential equations. In the absence of an analytical solution, the computer simulation must rest on iterative methods, which move from a current state of the system being considered to a subsequent state of this system. Each system is generally broken down into subsystems or loops whose respective evolutions are calculated in parallel in a synchronous manner. Consequently, the state of the system at the instant T+1 derives from the application in parallel of selected phenomena at the state of each loop at the instant T, without concentrating on the consequences this may cause between loops. Furthermore, this simulation technique does not favor the modification of simulation parameters during operation, nor the combination of different types of models, which impairs its scope of application.

The object of the invention is therefore to improve the situation.

It proposes in fact a device for simulating the real world, capable of being implanted in a computer capable of supporting in multi-task mode programming by activated objects representing systems to be simulated.

This device is characterised by the fact that it comprises software for simulating by objects the combined evolution of at least some of the activated objects, comprising:
state objects each containing at least one item of data relating to space and/or time and/or at least one item of property data, defining a current state,
interaction objects each containing the designation of at least one of the state objects and of at least one function applicable to at least one of these state objects, and defining at each instant the topology of the system being simulated,
a simulation manager capable of operating by sequences on a selection of interaction objects, and of activating each interaction object once only with each sequence, according to an order varying in an at least partially random manner from one sequence to the next, so as to apply each of its functions to the current state of each state object which it designates in order to make its state evolve towards a new current state.

In other words, the device according to the invention operates according to an mode which is asynchronous, since the respective states of the objects activated vary one after another within each sequence, taking into account the respective states of the other activated objects, and which is chaotic since the order of processing of each activated object varies in a random manner from one sequence to another. It is possible to activate or delete at any instant (i.e. in real time) one or more objects in order to modify the conditions of operation and/or the system simulated without having to restart the simulation as a whole, which gives the device a truly interactive character.

The simulation software may further comprise internal interaction objects containing the designation of a single state object and of at least one function applicable to this state object and mutual interaction objects containing the designation of at least two state objects and at least one function applicable to property data of these designated state objects.

Furthermore, at least some of the state objects may comprise a property data item which represents an intensive variable, and/or at least some of the interaction objects may comprise a function bringing about an extensive or intensive variable.

State objects may also be used at least some of which comprise state sub-objects as well as any interaction sub-objects operating on these state sub-objects.

Furthermore, the simulation software may comprise classes of objects which define structures of state objects and of interaction objects. The state and interaction objects are then derived from these classes by instancing.

Moreover, the simulation software may comprise a scheduler capable of operating either according to real-time mode, in which it operates according to a selected frequency, or according to a virtual-time mode, in which it operates periodically but for durations that vary from one period to another.

Further features and advantages of the invention will appear from a study of the detailed description below and from the attached drawings, which show:

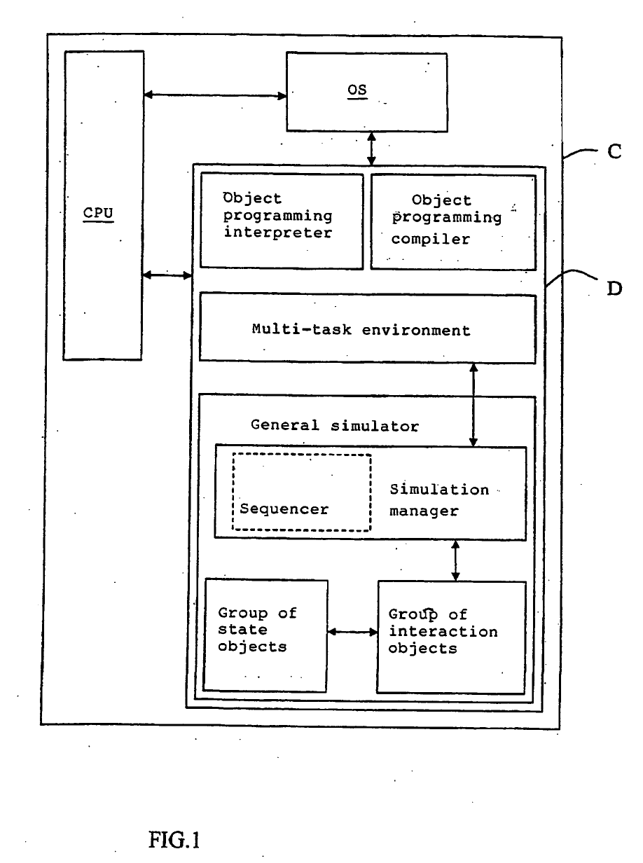

FIG. 1, very schematically, in the form of function blocks, a computer equipped with an embodiment of a simulation device according to the invention and

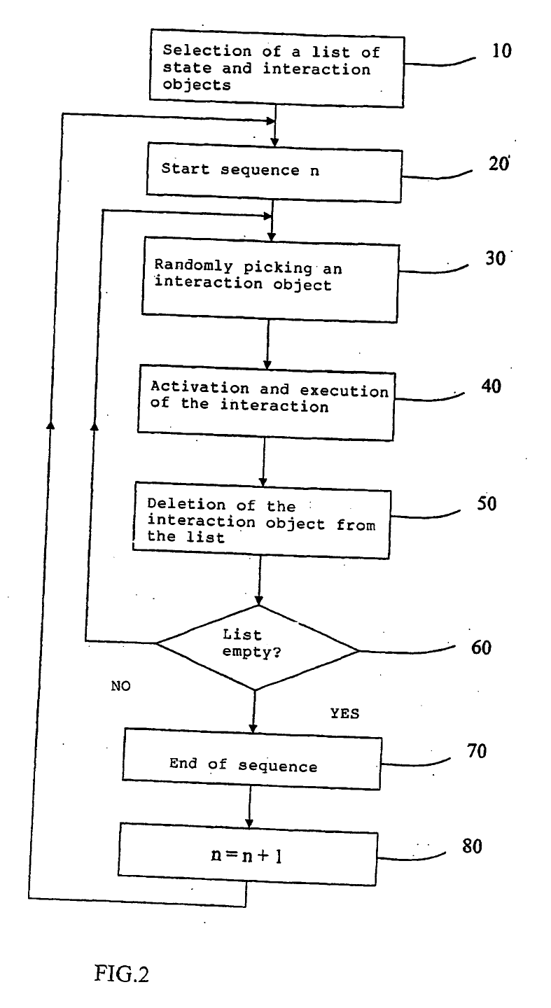

FIG. 2, a flow chart detailing an example of operation of a device according to the invention.

The attached drawings may not only complement the invention, but also contribute to its definition if necessary.

The invention relates to an interactive device for simulating the real world.

As is illustrated schematically and functionally in FIG. 1, a simulation device according to the invention D can be installed in a computer C comprising an operating system OS and processing and computing means CPU adapted to functioning in a multi-task mode, such as that offered by the environment or is described in particular in the document “Systems multi-agents” (Multi-agent Systems), pages 499 to 524, RSTI-TSI, 21/2002. Such a multi-task environment is particularly well adapted to programming by activated objects, e.g. in C++ or Java language. The multi-task environment or is is coupled, like the device D shown, to a compiler (here called “object programming compiler”. Furthermore, the or is environment may be coupled, like the device D shown, to a translator into C++ language (here called “object programming interpreter”) in order to improve its efficiency by compilation. This interpreter may even be adapted so as to form an on-line compiler in which the code executed is a code compiled on-line and modifiable in a dynamic manner. Such a multi-task environment, forming an evolution of or is, is known under the name AReVi.

The device D comprises software for simulating the combined evolution of activated objects (here called “general simulator”, More particularly, this simulation software (or general simulator) comprises objects which can be broken down into two groups.

A first group (called “state objects group” comprises objects known as “state”, each containing one or more spatial data (X, Y, Z) and/or time data (T) and/or one or more property data (or parameters, or even attributes), which together define a current state for the state object concerned.

In the simplest case, in which there is only one activated state object, the interaction object may not designate the state object, this being then designated implicitly.

Furthermore, in the simplest case, the space-time data item of a state object may be reduced to time only.

At least some of the state objects comprise a property data item representing an intensive variable.

In a first example relating to a chemical reactor, a state object may be a non-localised volume, and a property data item may be a concentration of a chemical substance.

In a second example relating to a blood vessel, a state object may be a volume loop localised in space, a space data item may be the geometric localisation within a selected reference point, and a property data item may be a chemical concentration or the temperature inside a loop.

A second group (named “interaction objects group”) comprises objects known as “interaction” (or activities) each containing the designation of at least one of the state objects and at least one function applicable to one at least of these designated state objects. The word “function” must be taken with its computer and not its mathematical definition, according to which it takes something (anything defined) to deliver a result. A function may thus designate a method, or a process, or a behaviour to be applied.

It is important to note that a function may depend on the property data of state objects.

At least some of the interaction objects comprise a property data item which represents an intensive or extensive variable.

In the first example cited above, relating to a chemical reactor, an interaction object may be a chemical reaction which handles the property data “concentration(s)” of the state object “volume” and the chemical reaction may be characterised by a “speed of reaction” parameter which may depend on the property data “concentration(s)”.

In the second example mentioned above, relating to the blood vessel, an interaction object may be a “heat diffuser” which balances the property data of temperature between two adjacent loops, and the heat diffuser may be characterised by the parameter “heat conductivity”.

Each interaction object (or activity) is therefore associated with at least one state object by a function, and a state object may be associated with plural interaction objects (or activities). A function only modifies the parameters of the state object(s) with which it is associated, without modifying the parameters of the other state objects and interaction objects. Furthermore, the features of the state objects may make it possible to select the function associated with the interaction objects or to modify its features. Furthermore, a function may be modified temporarily or permanently according to the parameters of an associated state object.

As will be seen below, an interaction object may form a definite interface, generally with an orientation between two media known as “source” and “target” (possibly merged) forming state objects. The interface then makes the link between the two media, which are linked at a given instant (notion of strong synchronicity) and modifies their respective parameters (e.g., the interface may be a difference in density between two media which brings about molecular diffusion at a certain rate).

Any type of interface is conceivable, in particular transport interfaces (e.g. of molecules, of heat, of current, or the like), and relaxation interfaces (e.g. of chemical or nuclear reactions). Consequently, a medium cannot have a spatial extension, this being induced, just as with any speeds, by one or more interfaces. However, an activity applied to a medium can modify the medium, as for example relaxation phenomena, which corresponds to internal self-activation in the medium.

The simulation software (or general simulator) also comprises a simulation manager coupled to the groups of state objects and of interaction objects and contrived so as to create its own sequencer or scheduler in order to operate sequentially on a selection of interaction objects of the said group of interaction objects. More particularly, the simulation manager is responsible for activating once upon each sequence, under the control of the sequencer or scheduler which it creates for the occasion, each interaction object selected according to an order which varies in an at least partly random manner from one sequence to the next, in order to apply each of its functions to the current state of each state object which it designates so as to evolve its state to a new current state.

In other words, as is shown by way of example in the flow chart of FIG. 2, the user selects first of all at a stage 10, from the first and second groups of objects, one or more state objects and one or more interaction objects which relate to this or these selected state object(s) in order that the device D simulates the spatio-temporal evolution of the system represented by the selected objects. This “pre-activates” each selected interaction object within the simulation software.

Then, at a stage 20, the simulation manager initialises a sequence counter by placing the value n of the counter at 1, and creates a list of state objects and of interaction objects. The first sequence (n=1) starts with a stage 30 in which the simulation manager selects in a random manner, from within the list of interaction objects, one of the selected interaction objects, which momentarily activates the same. Each function of the interaction object selected and activated is then applied to the current state of each state object of the list of state objects to which it is related, which possibly modifies its current state. The activation and application (or execution) of each function at each state object selected form the stage 40.

Then, at a stage 50, the simulation manager deletes from the list of interaction objects of the current sequence the interaction object which it has just applied.

Then, at a stage 60, the simulation manager effects a test intended to determine whether there are any other interaction objects left to apply in the list of interaction objects of the current sequence.

If the list of interaction objects of the current sequence is not empty, the simulation manager returns to the stage 30 in order to proceed to select in a random manner a remaining interaction object. As indicated above, it then activates this selected new interaction object and applies each of its functions to the current state of each state object, possibly modified by the activation of the preceding interaction object (which can no longer be used in the current sequence). The simulation manager reproduces these operations (selection-activation, application and update(s)) as many times as there are selected interaction objects in its list of interaction objects, so that each function of each interaction object is applied once only to each activated state object with which it is associated. Once this is finished, the first sequence (n=1), corresponding to the instant T=0, is completed.

When the list of interaction objects of the current sequence is empty, the simulation manager increments by one unit, at stage 70, the current value n of the sequence counter. Obviously, this stage 70 comprises a test of the number of sequences to be carried out. If the number of sequences carried out is equal to the maximum number provided, the simulation manager ends the simulation. On the other hand, if there remain at least one sequence to be carried out, the simulation manager returns to stage 20 to carry out a new sequence corresponding to an instant T+1, T+2, . . . , T+n. It then reiterates the above-mentioned operations with each new sequence.

The duration of simulation, and therefore the maximum number of sequences carried out by the simulation manager, depends on the application concerned, or on the parametering selected by the user taking account of the application. But, the simulation may be interrupted at any instant by the user by means of a stop command transmitted to the simulation software by virtue of a man/machine interface of the computer C. It is important to note that a simulation interrupted at the request of the user can be resumed subsequently.

Due to this sequential, chaotic mode of operation of the simulation software, the user may at any instant intervene in a simulation, either in the form of an “avatar” in order to interact himself with the simulation object, e.g. the medium, or to add to, or delete from, his selection one or more state objects and/or one or more interaction objects. The user may also decide to modify the definition (or structure) of one or more state or interaction objects at least partly. This gives the simulation software a large degree of interactivity.

Three examples for aiding understanding of what the state objects and interaction objects represent are given below. In order to avoid weighing down the description unnecessarily, the examples are simplified and reduced to what is necessary to permit the person skilled in the art to understand how the invention can be applied.

A first example relates to the simulation of the chemical kinetics within a chemical reactor. The chemical reactor is a state object representing a medium comprising chemical substances, and within which N chemical reactions can occur forming so many interaction objects.

The chemical reactor state object is for example associated with property data representing the concentrations (C1(T), C2(T), . . . , Cn(T)) at the instant T of the n chemical substances initially present in the reactor. These concentrations here define the state (at the instant T) of the chemical reactor state object, of which it is desired to simulate the temporal evolution.

Each chemical reaction interaction object is for example characterised by property data representing, firstly, the speed of the reaction V=f(C1, C2, . . . , Cn), secondly the reagents involved in the reaction (R1, R2, . . . , Rn), thirdly the resultant products of the reaction (P1, P2, . . . , Pm), and fourthly the stoichiometric coefficients defining the initial proportions of the reagents at T=0. Furthermore, each chemical reaction interaction object is for example associated with a function representing the behaviour of the reaction: in a first time, the current concentrations (C1 (T), C2(T), . . . , Cn(T)) are read of the reagents present in the chemical reactor at the instant T, and in a second time the speed of reaction V is calculated, which depends on the concentrations of reagents present in the chemical reactor, and in a third time, the concentrations of the reagents and of the products are modified after a time dT at the speed of the reaction V.

Here, each interaction object only acts on a single state object, so that it forms an internal interaction object.

In a first example, the user will therefore select his state object (i.e. the initial composition of his chemical reactor) and his N interaction objects (i.e. the N chemical reactions which are implied by the selected composition). The simulation manager can therefore start its sequential processing.

As indicated above, the user starts a first sequence by selecting in a random manner one of the N selected interaction objects. This interaction object is activated in order that it applies its function (behaviour of the reaction) to the current state of the only state object, defined here by the current concentrations (C1 (T), C2(T), . . . , Cn(T)) of the reagents (upon the first sequence T=0). The manager updates the concentrations (C1(T), C2(T), . . . , Cn(T)) of the reagents. Then, it selects in a random manner one of the N−1 remaining interaction objects in order to activate the same and apply its function to the new current state of the only state object. It reproduces these operations N times so that each function of each interaction object is applied once only to the state object. The first sequence is then finished.

The manager then starts a new sequence, corresponding to the instant T+1, if this proves necessary, by reiterating the above-mentioned operations. The simulation ends when there are no more reagents to produce the products, or when the user addresses a stop command to the simulation software.

A second example relates to the simulation of molecular diffusion of M diffusers within a space cut up into K loops.

Each of the K loops forms a state object characterised, for example, by a position data item (or topographical or geographical positioning in a 3D reference point) and by property data representing the concentrations (C 1(T), C2(T), . . . , Cn(T)) at the instant T of n chemical substances (S1, S2, . . . , Sn) present in the loop. These concentrations here define the state (at the instant T) of the loop.

Each of the M diffusers forms an interaction object characterised, for example, by property data (or parameters) representing, firstly, the substance diffused Si, secondly the speed of three-dimensional diffusion V=(Vx, Vy, Vz) of the substance Si, and thirdly the two loops between which the diffusion is taking place. Furthermore, each diffuser (interaction object) is for example associated with a function representing its behaviour: in a first time, the concentration Ci(T) of the substance Si to be diffused is read in each of the two loops, in a second time the quantities to be diffused are read (e.g. by using the generalised Fick's Law), and in a third time, the concentration of the diffuser Si is modified in each of the two loops after a time dT at the speed of diffusion V. The property data here represent the attributes (or parameters) of the function (behaviour of the diffuser).

Here, each interaction object acts on two state objects, so that it forms a mutual interaction object. Furthermore, each interaction object here has a conventional structure (or definition) based on at least one function designating at least one state object, as well as possibly parameters or rules or even laws connected to the function and forming property data. However, their structure may be more complex, e.g. when it comprises one or more interaction sub-objects. Furthermore, the loops are here of the three-dimensional (3D) type, but in certain applications they may be two-dimensional (2D) or even one-dimensional (1D).

In this second example, the user will therefore select his K state objects (i.e. the K diffusion loops) and his M interaction objects (i.e. the M diffusers). The simulation manager can therefore start its sequential processing.

It starts a first sequence by selecting in a random manner one of the M selected interaction objects. This interaction object is activated in order that it applies its function (behaviour of the diffuser), taking into account its own attributes, to the current state of the K state objects (loops), defined here by the current concentrations (C1(T), C2(T), . . . , Cn(T)) of the chemical substances (S1, S2, . . . Sn) in the different loops (at the time of the first sequence T=0). The manager updates the concentrations (C1)(T),C2(T), . . . , Cn(T)) of the substances (S1, S2, . . . , Sn) in each of the K loops. Then, it selects in a random manner one of the N−1 remaining interaction objects, in order to activate the same and to apply its function to the new current state of each state object. It reproduces these operations N times so that each function of each interaction object is applied once only to each state object. The first sequence is then finished.

The manager then starts a new sequence, corresponding to the instant T+1, if this proves necessary, by reiterating the above-mentioned operations. The simulation ends when the concentrations (C1(T), C2(T), . . . , Cn(T)) of the chemical substances (S1, S2, . . . , Sn) are respectively identical in each of the K loops, or if the user addresses a stop command to the simulation software.

In a third example, the two preceding examples can be combined so as to simulate the evolution of the chemical kinetics and of the molecular diffusion within one blood vessel.

For example, K state objects are selected forming N chemical reactors positioned in 3D space. Each chemical reactor is for example associated with a position data item (or geographical location in a 3D reference point) and to property data representing the concentrations (C1(T), C2(T), . . . , Cn(T)) at the instant T of n chemical substances (S1, S2, . . . , Sn) present in the loop. These concentrations define here the state (at the instant T) of the loop.

Furthermore, N+M interaction objects are selected forming N chemical reactions and M diffusers.

Each chemical reaction is for example associated with property data representing, firstly, the speed of the reaction V=f(C1, C2, . . . , Cn), secondly the reagents involved in the reaction (R1, R2, . . . , Rn), at T=0, thirdly, the resultant products of the reaction (P1, P2, . . . , Pm), and fourthly the stoichiometric coefficients defining the initial proportions of the reagents at T=0. Each chemical reaction is also, for example, associated with a function representing the behaviour of the reaction: in a first time, the current concentrations (C1(T), C2), . . . , Cn(T) of the reagents present in the chemical reactor at the instant T are read, in a second time the speed of reaction V is calculated, which depends on the concentrations of reagents present in the chemical reactor, and in a third time the concentrations of the reagents and products are modified after a time dT at the speed of reaction V.

Each diffuser is for example associated with property data representing, firstly, the substance diffused Si, secondly the three-dimensional diffusion speed V=(Vx, Vy, Vz) of the substance Si, and thirdly, the two loops between which the diffusion is taking place. Each diffuser is also, for example, associated with a function representing its behaviour: in a first time, the concentration Ci(T) of the substance Si to be diffused in each of the two loops is read, in a second time the quantities to be diffused are calculated (e.g. by using the generalised Fick's Law), and in a third time the concentration of the diffuser Si in each of the two loops is modified after a time dT at the speed of diffusion V. The property data represent here the attributes (or parameters) of the function (behaviour of the diffuser).

The function of the device is therefore identical to that presented in the preceding examples, but this time the concentrations of the different substances evolve not only according to the chemical reactions, but also according to the loops where they take place. Consequently, each sequence comprises N+M random draws making it possible to apply consecutively the functions of the N+M interaction objects to the K chemical reactors.

Obviously, the invention can be applied to far more complex applications than those presented above by way of illustrative example. It can also be applied to simpler applications in which the software is only applied to a single activated state object by means of a single internal interaction object. Furthermore, in certain applications, at least one of the state objects may have a complex structure (or definition) based on one or more state sub-objects (having the conventional structure of a state object), possibly associated with one or more interaction sub-objects (having the conventional structure of an interaction object).

We now refer to the table of Appendix X1, for a description, in relation to the code, of an example of an application of the invention using a state object known as “medium” and more particularly “medium class” and an interaction object known as “interface” and more particularly “interface class” The purpose of this application is to allocate an indication of colour to an indication of density within the medium.

The code only appears in the second column of the table, whose first column only comprises alphanumeric reference points not forming part of the code.

The Appendix X1 starts, at A, with “#include” declarations, which do not need to be explained in detail as they are well known to the person skilled in the art. Then, at B, an interface class is declared, associated with the medium class processed in detail at C. After the class heading C1, the medium class understands the declaration of specific methods C20 to C30, then at C4 a function (or method) “activate”, and finally protected variables stated at C5. In Appendix X1, the declarations of methods (or functions) are reduced by removing the definitions of type/parameters, as the person skilled in the art will find these in the detailed statement of each method.

Among the protected variables indicated at C5, one may note:
“interfaces”, which are assembled within a table of a particular type known as StlVector (standard C++ class), and
a variable “_it” which is of the ArRef type (class belonging to the AReVi environment).

Then comes the detail of the interface class (for the sake of uniformity, it remains designated B). It comprises a definition method and a construction method, followed by declaration of specific methods B20 to B31 and of the method activate B4. Finally, protected variables B5 are defined, where again one may note in particular:
a “_source” which is of the medium type, and
a “_target” which is also of the medium type.

The definitions of the methods of the medium class then appear (at C11-C14 and C20-C30) in great detail. The headings C11 to C13 define the medium class constructor. At C11 the protected variables of the medium class are initialised.

At C12 appears a definition of a 3D shape known as “Vrml”. The Vrml code permits 3D display on-line. This form is defined by a chain of characters according to the Vrml syntax described for example at the site http://www.vrml.org. This shape is then displayed and put into colours.

The heading C13 associates with the medium an activity intended to trigger the method activate of the heading C14.

The heading C14 is a destroyer of the medium state object.

The headings C20 to C30 inclusive give the detail of the construction of the specific methods already mentioned under the same identity for the medium class.

The activate method to be applied to the medium is defined in C4. It makes it possible to connect a colour indication to the density indication, and more particularly to change the colour by random drawing. In other words, the attributes red, green and blue of the medium are modified each time that activate is applied (or activated).

Then come the definitions for the interface class, with at B10-B11 the definition of the constructor. More particularly, at B10, the protected variables of the interface class are initialised, whereas at B11 the interface is associated with an activity intended to apply the activate method defined at B4.

The heading B 12 is a destroyer of the interface interaction object.

Then come the details of the specific methods B20 to B31 already mentioned.

The activate method of the interface is defined at B4. This involves calculating a diffusivity according to a source medium density and a target medium density, in order to propagate the distance between the two densities, if at least this distance is significant. The distance referenced “delta” is calculated as the application of a diffusivity function to the density of source medium rhos, decreased by the density of target medium rhot. To this end, one first requests of the source medium and of the target medium what their respective densities are. Then, the absolute value of the differences of the colours are calculated. If this absolute value is higher than a selected value (here equal to 0.01), the lowest density is increased and the strongest density is decreased. Then, the values are updated at a selected rate.

The headings B60-B63 make it possible to define the type of 3D display windows which will be used by the application.

Then comes an important element for the invention which is the scheduler or sequencer. The headings S10, S20, S21, S22, S30, S31 and S41 make it possible to initialise the simulation.

In fact, the heading S10 initialises a scheduler in virtual time, i.e. its operation is not forced to keep to real time, but each of its iterations represents logically, and not physically, a duration of one millisecond (1 ms). Obviously, the scheduler can also operate in real time. In this case, each of its iterations lasts physically for a selected period.

The heading S20 makes it possible to initialise the dimensions of the medium by virtue of the arguments of the line of command. The heading S21 makes it possible to initialise the media. The heading S22 makes it possible to create and initialise the interfaces.

The headings S31 and S32 carry out auxiliary display, which is carried out in this case by the special communication route with the screen known as an “aerror stream”.

The heading S41 displays the scene to be processed, in selected conditions of perspective.

Finally, the heading S50 is the main program main, which initialises operation of the system. More particularly, this program creates first of all a 3D system, then calls the same to activate the method given at the heading S10 in order that this creates the scheduler (or sequencer), the media and the interface.

Obviously, the structure of classes, presented above, can be resumed in the manner indicated schematically in Appendix X2.

The transition between the representation of Appendix X2 and the detailed code of Appendix X1 is considered accessible to the person skilled in the art, since an example thereof has been given.

The invention has numerous applications in numerous technical fields and in particular in the fields of chemistry, pharmacy, physics, aeronautics, architecture, in particular naval applications (e.g. for the behaviour study of a boat or offshore platform, as an alternative to or supplementary to dry docks), medicine, in particular within the scope of the research into the development and treatment of certain illnesses (e.g. cancers) or reaction mechanisms (e.g. the activation of insulin), ergonomics, in particular for the realisation of apparatus specifically adapted for disabled persons, and in the field of road traffic.

The invention is not limited to the embodiments of the simulation device described above solely by way of example, but includes any modifications which the person skilled in the art will be able to conceive of within the scope of the claims below.

1-10. (canceled)

11: A device for simulating the real world, configured to be implanted in a computer configured to support in a multi-task mode programming by activated objects representing systems to be simulated, including software simulating by objects shared evolution of at least some of the activated objects, comprising:
state objects each comprising at least one spatial and/or time data item and/or at least one property data item, defining a current state;
interaction objects each containing a designation of at least one of the state objects and of at least one function applicable to at least one of the state objects, and defining at each instant a topology of the system being simulated; and
a simulation manager configured to operate by sequences on a selection of interaction objects and to activate each interaction object once only with each sequence, according to an order varying in an at least partly random manner from one sequence to the next, so as to apply each of its functions to the current state of each state object which it defines to evolve its state to a new current state.

12: A device according to claim 11, wherein the simulation software comprises internal interaction objects, each capable of containing designation of a single state object and at least one function applicable to the single state object, and mutual interaction objects, each capable of containing the designation of at least two state objects and at least one function applicable to property data of the designated state objects.

13: A device according to claim 11, wherein the simulation software is configured to modify at least some of the functions according to at least one property data item of at least one associated state object.

14: A device according to claim 11, wherein the simulation software is configured to select at least some of the functions according to at least one property data item of at least one associated state object.

15: A device according to claim 11, wherein at least some of the state objects comprise a property data item representing an intensive variable.

16: A device according to claim 11, wherein at least some of the interaction objects have a function bringing about an extensive or intensive variable.

17: A device according to claim 11, wherein at least some of the state objects comprise state sub-objects.

18: A device according to claim 17, wherein at least some of the state objects comprise interaction sub-objects operating on the said state sub-objects.

19: A device according to claim 11, wherein the simulation software comprises classes of objects defining structures of state objects and of interaction objects, the state objects and interaction objects being derived from these classes by instancing.

20: A device according to claim 11, wherein the simulation software comprises a scheduler capable of operating according to one of two modes selected from a real-time mode, in which it operates according to a selected frequency, and a virtual-time mode in which it operates periodically but for durations which vary from one period to another.
